(19) United States
(12) Patent Application Publication
(10) Pub. No.: US 2007/0088572 A1
(43) Pub. Date: Apr. 19, 2007

(54) System and method for alert escalation processing in healthcare information systems

(75) Inventors: Joseph B. Susai, Lake Barrington, IL (US); Michael T. Randazzo, Cary, IL (US)

Correspondence Address: MCANDREWS HELD & MALLOY, LTD, 500 WEST MADISON STREET, SUITE 3400, CHICAGO, IL, 60661, US

(73) Assignee: General Electric Company

(21) Appl. No.: 11/399,954

(22) Filed: Apr. 7, 2006

Related U.S. Application Data
(60) Provisional application No. 60/726,536, filed on Oct. 14, 2005.

(51) Int. Cl. G06Q 10/00

(52) U.S. Cl. 705/2

(57) ABSTRACT

An alert management system and method for use in healthcare clinical decision support. The alert management system includes an alert mode and an escalation mode. The alert mode is capable of receiving a rule payload generated by a rule engine and is further capable of generating an initial alert message. The escalation mode is capable of transmitting the initial alert message to a recipient and is further capable of monitoring for a response. Monitoring for a response includes an alert escalation, which is capable of transmitting a subsequent alert message after the passage of a predetermined time duration. The method of alert management includes receiving a rule payload from a rule engine and generating an initial alert message. The method further includes transmitting the initial alert message to a recipient and monitoring for an acknowledgement from the recipient.

### CROSS-REFERENCE TO RELATED APPLICATION(S)

The present application claims the benefit of U.S. Provisional Application No. 60/726,536, filed on Oct. 14, 2005, entitled “System and Method for Clinical Decision Support”, which is herein incorporated by reference in its entirety.

### EDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The present invention relates generally to alert management for healthcare systems. More particularly, the present invention relates to systems and methods for processing alert escalations in healthcare information systems.

Numerous entities participate in the work flow of health services including organizations, administrators, patients, and individual practitioners such as doctors and nurses. Tasks such as medication monitoring, emergency hospitalization of patients, laboratory examination results, shipment of drugs, exchange of patient records among healthcare service providers, and other tasks, lead to a significant number of communications among the various health service entities. Thus, it is important in the healthcare field that both process integration and data integration of clinical information systems is achieved among the various health services entities.

Timely communication of accurate information is one important factor in providing quality healthcare services. One type of communication in healthcare services is the conveyance of urgent messages to a decision-maker responsible for the care of a patient, also known as alerts. Current practices for conveying alerts include using mobile telephones or pagers, but these practices alone do not provide seamless integration with existing and future healthcare information systems.

Recent advances in Internet technologies have created a global platform for healthcare organizations and affiliated individuals to communicate with one another, carry out time sensitive tasks, and provide value-added services to their customers and ultimately the patient. For end-users of healthcare information services, the use of mobile healthcare computing devices such as personal digital assistants (PDA) which may have advanced technologies like Web Application Protocol (WAP) and Short Message Service (SMS) is becoming a part of daily life.

Improvements in alert management can increase the timely response for healthcare applications addressing important needs of patients. Accordingly, it would be desirable to use alert management systems and methods in healthcare information services. Moreover, it would be desirable to use alert management system and methods for processing alert escalations in healthcare information service.

### BRIEF DESCRIPTION OF THE INVENTION

In one aspect of the present disclosure, an alert management system for use in healthcare clinical decision support systems is described. The alert management system includes an alert mode, wherein the alert mode is capable of receiving a rule payload generated by a rule engine. The alert mode is further capable of generating at least an initial alert message based on at least a portion of the rule payload. In another embodiment, the alert management system further includes an escalation mode, wherein the escalation mode is capable of transmitting at least a portion of the initial alert message to a recipient. The escalation mode is also capable of monitoring for a response by the recipient to the initial alert message. The monitoring can include an alert escalation, wherein the alert escalation is capable of transmitting at least one subsequent alert message after passage of a predetermined time duration. The predetermined time duration is established by the rule payload.

In another aspect of the present disclosure, a method of alert management for use in healthcare clinical decision support is described. The method of alert management includes receiving a rule payload from a rule engine; generating an initial alert message based on at least a portion of the rule payload; transmitting at least a portion of the initial alert message to a recipient; and monitoring for an acknowledgement from the recipient. The monitoring can include a capability to escalate an initial alert message by transmitting at least one subsequent alert message after passage of a predetermined time duration.

Another aspect of the present disclosure includes a computer readable medium, which has a set of alert management instructions for execution on a computing device. The instructions can include a rule engine routine for generating a rule payload or rule payload data. The instructions can further include an alert mode routine wherein the alert mode routine is capable of receiving the rule payload or rule payload data generated by the rule engine routine. The alert mode routine can further be capable of generating an initial alert message based on at least a portion of the rule payload. The instructions can also include an escalation mode routine wherein the escalation mode routine is capable of transmitting at least a portion of the initial alert message to a recipient application and is further capable of monitoring for a response by the recipient application to the initial alert message. Monitoring can include an alert escalation routine, where the alert escalation routine is capable of transmitting at least one subsequent alert message after passage of a predetermined time duration. The predetermined time duration can be established by the rule payload or the rule payload data.

In other embodiments, the alert message of the alert management system is generated using an alert payload template. In an embodiment, the escalation mode of the alert management system and method is further capable of continuously monitoring for a response by the recipient. In an embodiment, the escalation mode of the alert management system and method is capable of transmitting at least a portion of the alert message to a plurality of recipients. In an embodiment, the alert mode of the alert management system and method is capable of generating the alert message according to a recipient classification. In an embodiment, an audit monitor of the alert management system is capable of at least partially tracking information flow for at least one of the alert mode and the escalation mode. In an embodiment, the alert mode of the alert management system is further capable of receiving a clinical payload from the rule engine.

In other embodiments, the alert message is transmitted as at least one of an email, a content delivery to a repository system, an instant message, a page, and a text message. In an embodiment, the alert message is configured to trigger at least one of an audio signal and a video signal. In an embodiment, the escalation mode of the alert management system and method is further capable of identifying if the alert message seeks at least one of an acknowledgment from a recipient and response from a timer. In an embodiment, the escalation mode of the alert management system and method transmits subsequent alert message automatically. In an embodiment, the escalation mode of the alert management system and method is further capable of tracking acknowledgments from the recipients.

### BRIEF DESCRIPTION OF THE DRAWINGS

FIG. 1 illustrates an embodiment of an alert management system for healthcare clinical decision support.

FIG. 2 illustrates an embodiment of an alert mode for an alert management system.

FIG. 3 illustrates an embodiment of an escalation mode for an alert management system.

FIG. 4 illustrates an embodiment of alert management systems for healthcare clinical decision support.

FIG. 5 illustrates an embodiment for a method of alert management for healthcare clinical decision support.

The foregoing summary, as well as the following detailed description of embodiments, will be better understood when read in conjunction with the appended drawings. For the purpose of illustrating the present disclosure, certain embodiments are shown in the drawings. It should be understood, however, that the present disclosure is not limited to the arrangements and instrumentality shown in the appended drawings.

### DETAILED DESCRIPTION OF EMBODIMENT(S)

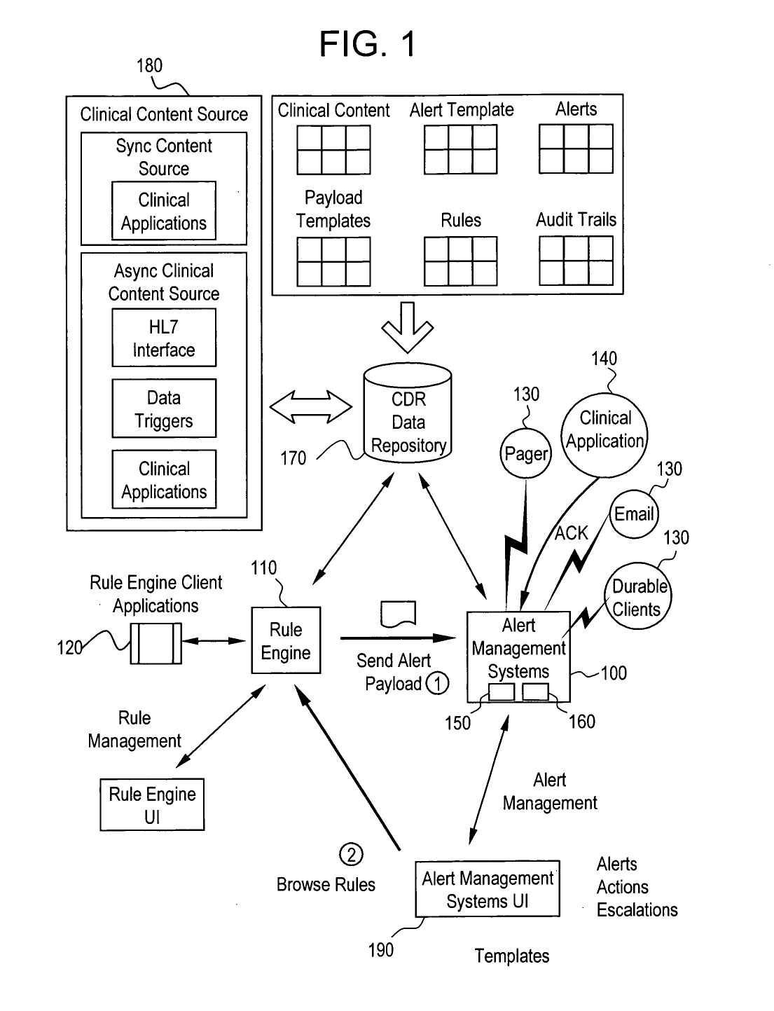

FIG. 1 illustrates an alert management system 100 for healthcare clinical decision support in accordance with an embodiment of the present disclosure. A rule engine 110 can communicate with client applications 120 operating within a larger clinical decision support system. The rule engine 110 can send an alert payload to the alert management system 100. The alert management system 100 can then send an alert message to one or more recipients or recipient applications 130. Where the alert message may seek acknowledgement(s) from recipient applications 130, a clinical application 140 or recipient applications 130 can send acknowledgement(s) back to the alert management system 100. The alert management system can include an alert mode 150 and an escalation mode 160. For example, the alert mode can be used to receive and/or process information from the rule engine 110. As another example, the escalation mode 160 can be used to transmit an alert message to recipient applications 130, monitor acknowledgement(s) from recipient applications 130 or clinical applications 140, and/or implement alert escalations.

The alert management system 100 and the rule engine 110 can communicate with a clinical data repository 170. The data repository 170 holds objects associated with the alert management system 100, such as alerts, alert templates, clinical content, payload templates, rules, audit trails, and other objects. The data repository 170 can also communicate with a clinical content source 180. Clinical content source 180 can decide which content matter having an associated rule can trigger an alert upon validation of the rule. For example, content matter, such as certain blood pressure readings, can constitute a rule that once validated generates an alert. Examples of clinical content source are clinical applications, data triggers, and Health Level Seven (HL7) interface feeds. Clinical content source can be updated asynchronously or synchronously. Examples of clinical content source that can be updated asynchronously are HL7 interfaces, data triggers, and clinical applications. Clinical applications are an example of content sources that can be updated synchronously.

The rule engine 110 can feed the alert management system 100 with a payload containing rule information and clinical content that may be associated with a rule. For example, the payload can include the following contents: rules, rule data, clinical data such as instrument readings and lab notes, patient information such as demographic details, care provider data, and other contents.

A user interface 190 can be used to manage the alert management system 100. For example, a user may want to browse the rules of the rule engine 110. A user may also, for example, want to manage the mapping between certain objects such as rules and alerts, alerts and alert templates, alert acknowledgement templates and escalation templates, or for payload templates.

Recipient applications 130 receive an alert message from the alert management system 100. The recipient applications 130 can process the alert message and can also send acknowledgement data back to the alert management system 100. The alert message may, for example, contain a request for an acknowledgment from a recipient. Recipient applications 130 can include such devices as phones, pagers, email clients, instant messages, or portable digital assistants. Recipient applications can also include, as further examples, a clinical application, durable subscribers, a database repository, or a service provider's repository.

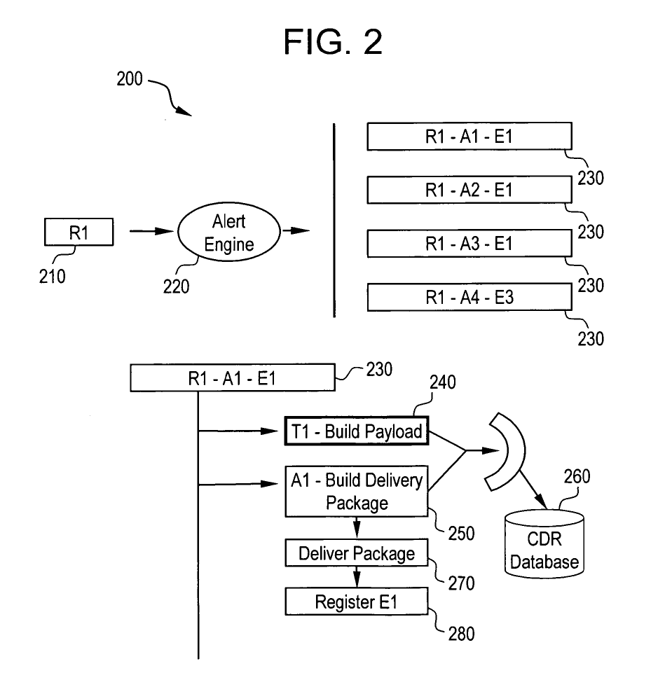

FIG. 2 illustrates an alert mode 200 of an alert management system in accordance with an embodiment of the present disclosure. A rule 210 and/or a clinical payload content can be received by an alert engine 220 for subsequent processing and for sending subsequent notification(s) to recipient(s). The rule 210 may be received from a rule engine and the clinical payload may be received by way of a rule engine or a data repository. The alert engine 220 can receive rules and clinical payloads using, for example, a local or remote Java Naming and Directory Interface (JNDI) or Web services. The alert engine 220 can process the rule and clinical payload using, for example, a stateless Worker Enterprise Java Bean (EJB) to prepare a notification. The stateless Worker EJB can operate within the alert engine 220 as illustrated in FIG. 2 to map at least one notification. Notification mapping may include the rule, the clinical payload, and the process mapping for the notification process.

In FIG. 2, a rule 210 and/or a clinical payload can be received by the alert engine 220. Based on the rule 210, one or more alert notifications 230 are mapped where each notification can include different content. For example, a single rule, R1, may result in mapping of four different alert notifications, A1, A2, A3 and A4, where each alert notification may represent a task that needs to be completed for a patient such as administering a certain medication or taking a chest x-ray. Each alert can also have an escalation, El, E3, associated with it that can be managed in an escalation mode.

In the example of FIG. 2, the single rule, R1, has four mapped alert notifications 230: R1-A1-E1, R1-A2-E1, R1-A3-E1, and R1-A4-E3. Each mapped alert notification 230 includes building an alert payload 240 and building a delivery package 250. The alert payload 240 and delivery package 250 can be built by accessing information from a clinical data repository 260. Communication with the data repository 260 can occur using Java Database Connectivity (JDBC). The process of building the alert payload 240 includes determining the content of the message that may be sent to a recipient or a recipient application. The process of building the delivery package may include, for example, identifying the recipients or recipient applications for the alert payload and how acknowledgments for a transmitted alert payload, if needed, are to be tracked. After the alert payload 240 and delivery package 250 are built, the alert payload 240 can be delivered 270 according to the mapping from the delivery package 250. Where an alert payload 240 or a delivery package 250 asks for an acknowledgement from a recipient or a recipient application, an escalation mode can be triggered with the registration of an escalation 280.

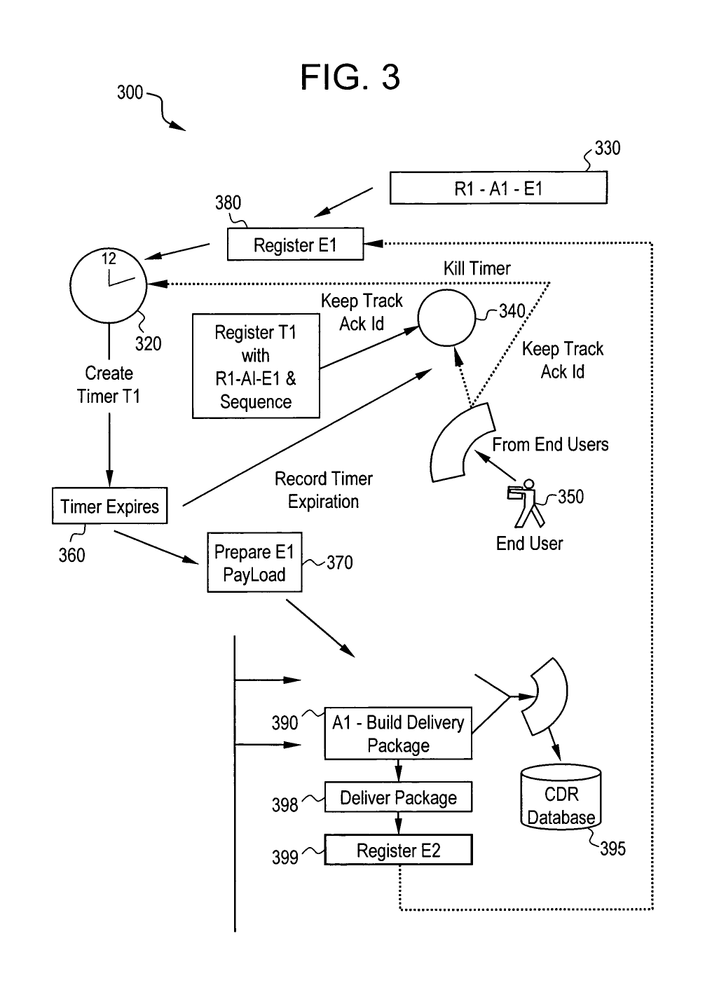

FIG. 3 illustrates an escalation mode 300 of an alert management system in accordance with an embodiment of the present disclosure. The escalation mode 300 can be triggered where an alert notification 330 needs an acknowledgement from a recipient or a recipient application 350. An escalation is registered 380 with the escalation mode 300, which can track the status of an acknowledgement from a recipient or recipient application 350 using, for example, a separate tracking field. The period for a given escalation can be monitored by an entity that keeps track of time. For example, a timer task 320 that uses a Java utility timer can be used to monitor an escalation period. During the escalation period, an acknowledgement monitor 340 can be used to track acknowledgement(s) of transmitted alert messages from recipient(s) or recipient application(s) 350. If an acknowledgement is not received to a registered escalation 380 before the expiration of a predetermined time duration, the timer can expire 360. The length of a predetermined time duration can depend on the rule and payload information that triggered the alert management system. Generally, the more critical the need for an acknowledgement from the recipient 350, the shorter the time duration of the escalation period.

Where the timer expires 360, the timer expiration may be recorded by the acknowledgement monitor 340. The escalation mode 300 can also prepare subsequent escalation(s) for unacknowledged alert(s). A subsequent payload 370 and alert delivery package 390 can then be built by accessing further information from a data repository 395. The process of building the alert payload can include determining the subsequent content of the alert notification that may be sent to a recipient 350. The process of building the delivery package may include identifying the recipients 350 of the subsequent alert payload and tracking an acknowledgment, if one is needed, for a transmitted alert payload. After the subsequent alert payload 370 and subsequent delivery package 390 are built, the alert payload 370 can be delivered 398 to recipients or recipient applications 350 according to the mapping from the delivery package 390. Where an alert payload 370 or a delivery package 390 asks for an acknowledgement from the recipient 350 of the transmitted alert payload, a subsequent escalation can be registered 399 and the system may continue within the escalation mode 300 with the subsequent escalation(s). This process can be repeated a number of times until after the Nth escalation period when the acknowledgement(s) are received from the recipient or recipient applications 350. The processes of the escalation mode 300 can be set up to take place using, for example, JNDI lookup or Web services. An escalation may continue until an acknowledgement is received. An escalation may also continue until a new alert notification is received that may supersede the earlier alert notification.

Certain embodiments of the disclosure contemplate automatic escalation of unacknowledged alert notifications including, for example, real-time escalation. Such an embodiment is particularly useful where critical alerts are not responded to with a predetermined time duration. Other embodiments contemplate a configurable payload for notifications such as through the user interface 190 shown in FIG. 1. Another embodiment contemplates monitoring unacknowledged or more frequently escalated alert notifications. Template concepts for payload message and for associating templates with alerts are also contemplated.

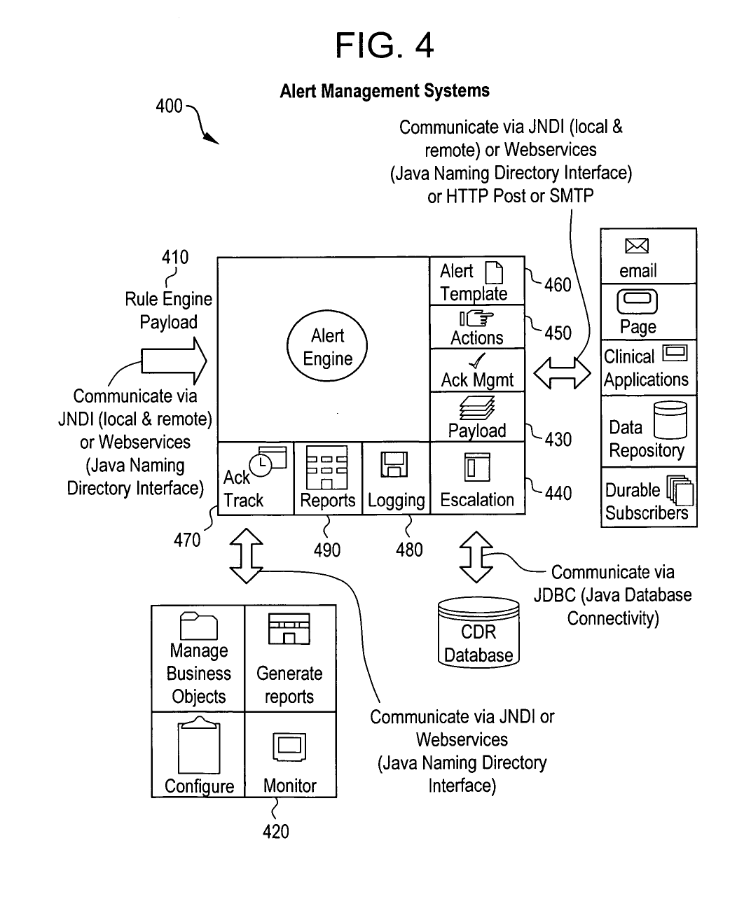

FIG. 4 illustrates alert management systems 400 in accordance with another embodiment of the present disclosure. Rule engine payloads 410 can be objects that are exchanged from a rule engine to alert management systems 400 to carry out an alert action. Rule engine payloads 410 can contain a rule identifier used to generate the payload 410 and can further contain pertinent clinical content that initiated the rule triggering. For example, “Rule #625, 5.00 PM, patient 00041002, chest X-ray” could be a rule engine payload 410. Rules are a part of a rules engine clinical decision support system or method. Rules can include identifiable and definitive steps than can be validated with a “yes” or “no” answer, where a “yes” to a rule results in some action. For example, if the answer is “yes” to the rule “If STAT Radiology order is placed . . .” then some action will result.

An alert management system 400 can include a user interface 420. The user interface 420 can be used to generate reports, configure the alert management system 400, or to manage various objects such as, for example, alert payload 430 or escalation 440.

Alerts can be actions carried out to satisfy a rule firing or triggering within a rule engine. Alerts contain actions 450 (for example, an email or page) that need to happen, the type of alert (for example, the message or the priority), the type of template 460 used to generate that the payload 430 that goes within the alert action 450 and escalation procedures 440 that follow for alerts that need acknowledgement. For example, an alert can include the action, alert type, alert template, alert payload, and escalation in satisfaction of a rule firing within the rule engine.

Alerts actions 450 can be an operation for carrying out a message or payload 430 to a recipient or recipient application. Typical alert actions can include email, page, content delivery to data repository systems, durable subscriber systems, and other actions. An example of an alert action can be: “e-mail radiology department”.

Alert types can be used to form the sensory notification desired for a recipient of an alert. The alert type can specify the priority and set the expected behavior at recipient devices, such as through the use of visual or audio alert types. For example, an alert type can be: “Priority 1 alert. So blink an icon and make an audible alert”.

An alert template 460 can be used to format in a standard form the end-package that reaches recipients along with the alert message. For example, an alert template can specify: “<mm>had stat <order text>ordered at <order time>”.

An alert payload 430 is the actual message the recipients receive upon the activation of an alert. For example, the alert payload 430 can include the following information: “00041002 had stat chest x-ray ordered at 5.00 PM-Priority 1, Rule #625, category-order”.

Escalation 440 is a procedure that occurs when an alert that seeks an acknowledgement is left unacknowledged for a specific amount of time. An escalated alert can be issued which may request a faster response from a recipient. An example of an escalation can be: “if radiology does not acknowledge in 5 minutes, page radiology dept”. Such an escalation can occur automatically. As shown in the example, escalation 450 can work together with an acknowledgement tracker 470 and can include a timer set for predetermined time duration(s).

An audit trail can include logging 480 the flow of objects within the alert management system 400. The audit trail can, for instance, collect the flow of which can be summarized in an audit report 490. Such operations can assist healthcare applications administrators to fine-tune the “work-flow” or clinical applications. An example of an audit report 490 based on audit trail data can be: “STAT Radiology done at 5.00 PM-Email alert issued at 5.05 PM-No email response received till 5:10 PM-Page Alert Issued at 5:10 PM-Page alert acknowledged at 5:15 PM”.

The alert management system 400 can also generate different payloads 430 based on who may be the recipient of the payload information. For instance, the details or the visibility of an alert payload may be selected based on a classification of recipients. Examples recipient classifications can include: medical student, nurse, administrator, physician, or physician group.

The alert management system 400 can also receive a recipient payload, which may include a message format, for information that is sent from recipients or recipient applications to the alert management system 400. The recipient payload can include the information that acknowledges the receipt of an alert. An example of the format of a recipient payload can be: “alert #ID, user: nurse, timestamp, comments”.

Communication between the various components of an alert management system can occur using local or remote JNDI or Web services. Communication can also occur using, for example, Hypertext Transfer Protocol (HTTP) post or Simple Mail Transfer Protocol (SMTP), such as for communications with recipients or recipient applications. When the alert management system accesses a clinical data repository, communication may also occur using JDBC.

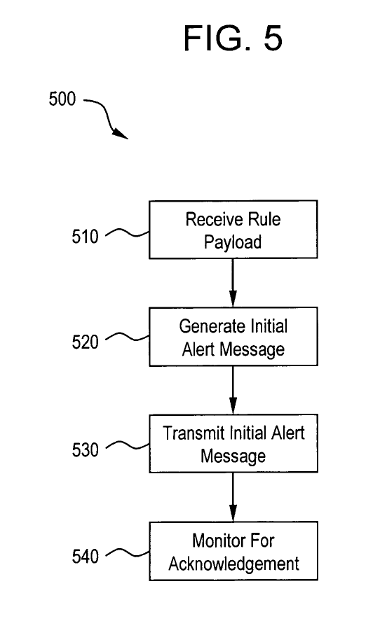

FIG. 5 illustrates a method of alert management 500 for use in healthcare clinical decision support in accordance with an embodiment of the present disclosure. The method can include receiving 510 a rule payload from a rule engine. Using at least a portion of the rule payload, an initial alert message can be generated 520. At least a portion of that initial alert message can then be transmitted 530 to recipient(s) or recipient application(s). After the initial message is transmitted, monitoring 540 can be done for acknowledgement(s) from the recipient(s) or recipient application(s). Monitoring 540 can include escalating the initial alert message where no acknowledgement is received from the recipient. Monitoring can include escalation(s) where at least one subsequent alert message can be transmitted after the expiration of predetermined time period(s).

Monitoring 540 for the acknowledgement can occur continuously, and where no acknowledgement is received, a subsequent alert message can be transmitted automatically. The method can include sending one or more alert messages to one or more recipients. Some of the alert message may be custom formatted to accommodate the needs of the recipient. For instance, a nurse may receive a different message than the doctor based on the same event that triggers the alert message. Monitoring 540 will generally include tracking for the receipt of either an acknowledgement or the expiration of a timer. The parameters that determine what is monitored and the duration can be set by the rule payload.

The alert management system can also be in the form of a computer readable medium having, for example, the embodiments as a set of instructions or routines for execution on a computing device. The instruction, for example, can be in the form of computer code and may be stored on any recognized computer readable medium. Examples of computer readable medium include compact disks, memory cards, memory sticks, hard disk drives, computer disks, ROM, and any other media.

While particular elements, embodiments, and applications of the present invention have been shown and described, it will be understood, of course, that the invention is not limited thereto since modifications can be made by those skilled in the art without departing from the scope of the present disclosure, particularly in light of the foregoing teachings. Therefore, it is intended that the invention not be limited to the particular embodiments disclosed, but that the invention will include all embodiments falling within the scope of the appended claims.

1. An alert management system for use in healthcare clinical decision support, the alert management system comprising:
(a) an alert mode, wherein said alert mode is capable of receiving a rule payload generated by a rule-engine, said alert mode is further capable of generating an initial alert message based on at least a portion of said rule payload; and
(b) an escalation mode, wherein said escalation mode is capable of transmitting at least a portion of said initial alert message to a recipient and is further capable of monitoring for a response by said recipient to said initial alert message;
wherein said monitoring comprises an alert escalation, wherein said alert escalation is capable of transmitting at least one subsequent alert message after passage of a predetermined time duration, wherein said predetermined time duration is established by said rule payload.

2. The alert management system of claim 1, wherein said alert message is generated using an alert payload template.

3. The alert management system of claim 1, wherein said escalation mode is further capable of continuously monitoring for said response by said recipient.

4. The alert management system of claim 1, wherein said escalation mode is capable of transmitting at least a portion of said alert message to a plurality of recipients.

5. The alert management system of claim 1, wherein said alert mode is capable of generating said alert message based on a recipient classification.

6. The alert management system of claim 1, wherein an audit monitor is capable of at least partially tracking information flow for at least one of said alert mode and said escalation mode.

7. The alert management system of claim 1, wherein said alert mode is further capable of receiving a clinical payload from said rule engine.

8. The alert management system of claim 1, wherein said alert message is transmitted as at least one of an email, a content delivery to a repository system, an instant message, a page, and a text message.

9. The alert management system of claim 1, wherein said alert message is configured to trigger at least one of an audio signal and a video signal.

10. The alert management system of claim 1, wherein said escalation mode is further capable of identifying if said alert message seeks at least one of an acknowledgment from a recipient and a response from a timer.

11. The alert management system of claim 1, wherein said escalation mode transmits subsequent alert message automatically.

12. The alert management system of claim 1, wherein said escalation mode is further capable of tracking acknowledgments from said recipients.

13. A method of alert management for use in healthcare clinical decision support, the method of alert management comprising:
(a) receiving a rule payload from a rule engine;
(b) generating an initial alert message based on at least a portion of said rule payload;
(c) transmitting at least a portion of said initial alert message to a recipient; and
(d) monitoring for an acknowledgement from said recipient, wherein said monitoring comprises a capability to escalate an initial alert message by transmitting at least one subsequent alert message after passage of a predetermined time duration.

14. The method of alert management of claim 13, wherein said monitoring for an acknowledgement is continuous.

15. The method of alert management of claim 13, wherein said alert message is transmitted to a plurality of recipients.

16. The method of alert management of claim 13, wherein said alert message is generated based on a recipient classification.

17. The method of alert management of claim 13, wherein said monitoring is further capable of identifying if said alert message seeks at least one of an acknowledgment from a recipient and a response from a timer.

18. The method of alert management of claim 13, wherein a subsequent alert message is transmitted automatically.

19. The method of alert management system of claim 13, wherein said monitoring is further capable of tracking acknowledgments from said recipients.

20. A computer readable medium having a set of instructions for execution on a computing device, said set of instructions comprising:
a rule engine routine for generating a rule payload;
an alert mode routine, wherein said alert mode routine is capable of receiving said rule payload generated by said rule engine routine, said alert mode routine is further capable of generating an initial alert message based on at least a portion of said rule payload; and
an escalation mode routine wherein said escalation mode routine is capable of transmitting at least a portion of said initial alert message to a recipient application and is further capable of monitoring for a response by said recipient application to said initial alert message;
wherein said monitoring comprises an alert escalation routine, wherein said alert escalation routine is capable of transmitting at least one subsequent alert message after passage of a predetermined time duration.
